(19) United States
(12) Patent Application Publication
(10) Pub. No.: US 2025/0020949 A1
(43) Pub. Date: Jan. 16, 2025

(54) Stress-Optic Phase Controller Having Enhanced Stress-Inducing Capability

(71) Applicant: LioniX International BV, Enschede (NL)

(72) Inventors: Arnoud Sebastiaan EVERHARDT, Enschede (NL); Ronald DEKKER, Enschede (NL); René Gerrit HEIDEMAN, Enschede (NL); Thi Lan Anh TRAN, Enschede (NL)

(21) Appl. No.: 18/763,392

(22) Filed: Jul. 3, 2024

Related U.S. Application Data
(60) Provisional application No. 63/526,291, filed on Jul. 12, 2023.

(51) Int. Cl. G02F 1/01; G02B 6/02; G02B 6/12; G02B 6/293; G02F 1/025; G02F 1/225

(52) U.S. Cl. CPC G02F 1/0134; G02B 6/02076; G02B 6/29353; G02F 1/225; G02B 2006/12097; G02B 2006/12142; G02F 1/025

(57) ABSTRACT

The present disclosure is directed to systems and methods for controlling the phase of at least one light signal in a planar-lightwave circuit (PLC) via a stress-optic (SO) phase controller. SO phase controllers in accordance with the present disclosure include a stress-inducing element disposed on a dome-shaped surface of the upper cladding of an integrated-optics-based waveguide, where the dome surface includes little or no linear portion. Such a dome-shaped surface improves the effectiveness with which the stress-inducing element can impart stress in the waveguide materials, thereby reducing the drive voltage and/or interaction length required to induce a given phase shift as compared to the prior art.

### CROSS REFERENCE TO RELATED APPLICATIONS

This case claims priority of U.S. Provisional Patent Application Ser. No. 63/526,291, filed Jul. 12, 2023 (Attorney Docket: 142-047PR1), which is incorporated herein by reference. If there are any contradictions or inconsistencies in language between this application and the provisional application incorporated by reference that might affect the interpretation of the claims in this case, the claims in this case should be interpreted to be consistent with the language in this case.

### TECHNICAL FIELD

The present disclosure relates to integrated optics in general and, more specifically, to controllers for controlling the phase of an optical signal propagating in a surface waveguide of a planar waveguide circuit.

### BACKGROUND

A Planar Lightwave Circuit (PLC) is an optical system comprising one or more integrated-optics-based waveguides that are disposed on the surface of a substrate, where the waveguides are typically combined to provide complex optical functionality. These “surface waveguides” typically include a core of a first material that is surrounded by a cladding comprising a second material having a refractive index that is lower than that of the first material. The change in refractive index at the interface between the materials enables internal reflection of light propagating through the core, thereby guiding the light along the length of the surface waveguide.

PLC-based devices and systems have made significant impact in many applications, such as optical communications systems, sensor platforms, solid-state projection systems, and the like. Surface-waveguide technology satisfies a need in these systems for small, reliable optical circuit components that can provide functional control over a plurality of optical signals propagating through a system. Examples include simple devices (e.g., 1×2 and 2×2 optical switches, Mach-Zehnder interferometer-based sensors, etc.), as well as more complex, matrix-based systems having multiple surface waveguide elements and many input and output ports (e.g., wavelength add-drop multiplexers, cross-connects, wavelength combiners, etc.).

Common to many such systems is a need to control the phase of one or more light signals as they propagate through the system-preferably with negligible excess loss. Phase controllers are critical components in, for example, variable attenuators and switches, as well as other devices.

Historically, integrated-optic phase controllers typically control the phase of a light signal propagating through a waveguide by virtue of the electro-optic effect, the thermo-optic effect, or the photo-elastic effect. Unfortunately, electro-optic-based phase controllers tend to have significant excess loss due to the fact that they inherently perturb the optical mode of the light signal, thereby making them unsuitable for many applications.

A TO phase controller takes advantage of the fact that the refractive index (i.e., the speed of light in a material) is temperature-dependent (referred to as the thermo-optic effect) by including a thin-film heater that is disposed on the top of the upper cladding of a surface waveguide. Electric current passed through the heater generates heat that propagates into the cladding and core materials, changing their temperature and, thus, their refractive indices. TO phase controllers have demonstrated induced phase changes greater than 2π.

To form an optical switching element, a TO phase controller can be included in a surface waveguide element, such as a Mach-Zehnder interferometer (MZI). In an MZI switch arrangement, an input optical signal is split into two equal parts that propagate down a pair of substantially identical paths (i.e., arms) to a junction where they are then recombined into an output signal. One of the arms incorporates a TO phase controller that controls the phase of the light in that arm. By imparting a phase difference of π between the light-signal parts in the arms, the two signals destructively interfere when recombined, thereby canceling each other out to result in a zero-power output signal. When the phase difference between the light-signal parts is 0 (or n*2π, where n is an integer), the two signals recombine constructively resulting in a full-power output signal.

A TO phase controller does not significantly affect the optical mode propagating through its underlying waveguide; therefore, they can function without significant excess loss. Unfortunately, the power consumption of a TO phase controller can be very high (>100 mW in a static situation) which requires cooling control elements in its package or limits its suitability in low-power applications. In addition, TO phase controllers are too slow for many applications because waveguide materials normally have low thermal-conductivity coefficients. As a result, the time required to heat or cool a surface waveguide structure can be very long (for example, 250 microseconds for a glass-based waveguide).

More recently, in part to address the shortcomings of thermo-optic tuning, stress-optic-based phase-tuning capability exploiting the photo-elastic effect has been demonstrated by incorporating a piezoelectric element disposed on a surface waveguide structure. By virtue of the photo-elastic effect, a stress-optic (SO) phase controller can induce a change in the refractive index of the materials of a waveguide with which it is operatively coupled by inducing a stress in the materials, as discussed in, for example, U.S. Pat. Nos. 9,221,074, 9,764,352, and 10,241,352, each of which is incorporated herein by reference. Since the piezoelectric element is external to the waveguide materials, it does not perturb the optical mode of the light signal upon which it operates; therefore, like the TO phase controller, an SO phase controller does not typically exhibit significant excess optical loss. In addition, a piezoelectric element consumes very little power and can quickly impart stress into their underlying materials. As a result, SO phase controllers are less power-hungry and faster than TO phase controllers, making them attractive for many applications.

Unfortunately, while prior-art SO phase controllers have shown a capability of inducing a 2π phase shift on an optical signal in as little as a few microseconds and static power consumptions <1 μW, they require higher voltages than thermo-optic phase controllers and significantly greater length over which the stress must be induced in a surface waveguide. For instance, while a thermo-optic phase controller might require an interaction length of approximately 1 mm to induce a 2π phase shift, the required interaction length for a comparable prior-art SO phase controller might be 2 cm or more. As a result, the cost associated with conventional SO phase controllers can be prohibitively high due to the large chip area required and/or expensive high-voltage drive electronics.

The need for a fast, space-efficient, lower-voltage, low-power-consumption approach to phase control of a light signal propagating in a surface waveguide remains, as yet, unmet in the prior art.

### SUMMARY

The present disclosure is directed toward planar-lightwave circuits and/or photonic integrated circuits (PIC) comprising one or more SO phase controllers having lower drive voltage requirements and/or requiring less chip real estate. Embodiments in accordance with the present disclosure are particularly well suited for use in systems such as microwave photonics, LiDAR and the like.

The present disclosure provides an advance over the prior art by including features in an SO phase controller that improve the efficiency with which the photo-elastic effect can be induced in a waveguide. Specifically, a carefully shaped dome structure is included in the upper cladding of the waveguide, in which the dome has little or no “flat” portion above the waveguide core. As a result, a stress-inducing element disposed on the top surface of the dome more effectively imparts stress into the waveguide materials, enabling a greater change in the refractive index of the material with lower drive voltages and/or shorter interaction length. Embodiments in accordance with the present disclosure are capable of the practical realization of phase changes that can be significantly greater than 2π at moderate drive voltages over relatively short interaction lengths.

Like SO phase controllers known in the prior art, SO phase controllers in accordance with the present disclosure include a phase-control element disposed on the top surface of the upper cladding of an integrated-optics waveguide. The phase-control element includes a piezoelectric element configured to induce a refractive index change in the underlying waveguide by imparting a stress in at least a portion of its material when energized by a control signal.

In sharp contrast to the prior art, the upper cladding of the waveguide includes a dome that is substantially vertically aligned with its waveguide core, where the dome has a surface that has only a very small flat portion or, in some embodiments, no flat portion at all (i.e., it is flat-zone-free).

An illustrative embodiment is a photonic circuit comprising an integrated-optics-based asymmetric Mach-Zehnder Interferometer (aMZI) that is configured as an optical switch. The aMZI includes input and output ports that are separated by first and second arms having different lengths, where the first arm includes an SO phase controller in accordance with the present disclosure, while the second arm does not include a phase controller. The SO phase controller includes a phase-control element having a piezoelectric layer disposed between lower and upper electrodes, where the lower electrode is disposed on and in physical contact with a flat-zone-free dome structure located in the upper cladding of the waveguide of the first arm such that the dome resides directly above the waveguide core.

The SO phase controller is configured to induce up to a 2π relative phase shift in the light signals propagating through the first and second arms, enabling the output signal to have an intensity that is within the range of approximately 0% to approximately 100% of the intensity of the input signal. In other words, the aMZI can function as a variable-optical attenuator as well as an on-off optical switch, if desired.

In some embodiments, an SO phase controller includes a phase-control element that is disposed on a dope structure whose top surface does include a flat zone; however, in accordance with the present disclosure, in such embodiments, the width of the flat zone is smaller than the width of the underlying core of the waveguide.

In some embodiments, a photonic system includes an MZI having arms of equal length.

In some embodiments, an aMZI or MZI includes a phase controller on each arm.

In some embodiments, an SO phase controller includes a phase-control element having a piezoelectric layer located directly on and in contact with a dome in the upper cladding of a waveguide, where the electrodes of the phase-control element are disposed on the same surface of the piezoelectric layer and located on either side of the waveguide core.

An embodiment in accordance with the present disclosure is a planar-lightwave circuit (PLC) disposed on a substrate, the PLC comprising: a first waveguide including: (i) a first lower cladding; (ii) a first core disposed on the first lower cladding, wherein the first core has a first width; and (iii) a first upper cladding disposed on the first core, wherein the first upper cladding includes a first dome having a first surface that includes a first flat zone having a second width that is less than the first width, wherein the first dome is at least partially disposed above the first core; and a first phase controller disposed on the first dome, wherein the first phase controller includes: (i) a first piezoelectric layer; and (ii) first and second electrodes that are electrically connected with the first piezoelectric layer; wherein the first phase controller is configured to induce a refractive-index change in the first waveguide by imparting a stress in at least one of the first core and first upper cladding.

Another embodiment in accordance with the present disclosure is a method for forming a planar-lightwave circuit (PLC) on a substrate, the method comprising: forming a first waveguide on the substrate such that the first waveguide includes a first lower cladding, a first core having a first width, and a first upper cladding having a first dome having a first flat zone having a second width that is less that the first width; and forming a first phase controller disposed on the first dome, wherein the first phase controller includes a first piezoelectric layer and first and second electrodes that are electrically connected with the first piezoelectric layer; wherein the first phase controller is formed such that it is operative for inducing a first refractive-index change in the first waveguide by imparting a first stress in at least one of the first core and the first upper cladding.

### BRIEF DESCRIPTION OF THE DRAWINGS

FIG. 1 depicts a schematic drawing of a top view of a PLC-based variable optical attenuator (VOA) comprising a stress-optic (SO) phase controller in accordance with the present disclosure.

FIG. 2 depicts a schematic drawing of a cross-sectional view of an SO phase controller in accordance with the prior art.

FIG. 3 depicts a schematic drawing of a cross-sectional view of an SO phase controller in accordance with the present disclosure.

FIG. 4 depicts a schematic drawing of a cross-sectional view of another SO phase controller in accordance with the present disclosure.

FIG. 5 depicts a schematic drawing of a cross-sectional view of yet another SO phase controller in accordance with the present disclosure.

FIG. 6 depicts a schematic drawing of a cross-sectional view of another SO phase controller in accordance with the present disclosure.

FIG. 7 depicts a schematic drawing of a cross-sectional view of yet another SO phase controller in accordance with the present disclosure.

FIG. 8 depicts a schematic drawing of a top view of an alternative embodiment of a PLC-based VOA comprising SO phase controllers on each arm of an aMZI in accordance with the present disclosure.

FIG. 9 depicts a schematic drawing of a cross-sectional view of phase-control module 802 taken through line b-b as shown in FIG. 8.

FIGS. 10A-C depict simulations showing the stress fields developed in arms 112A and 112B in response to different voltage configurations applied to electrodes 906-1 through 906-3.

### DETAILED DESCRIPTION

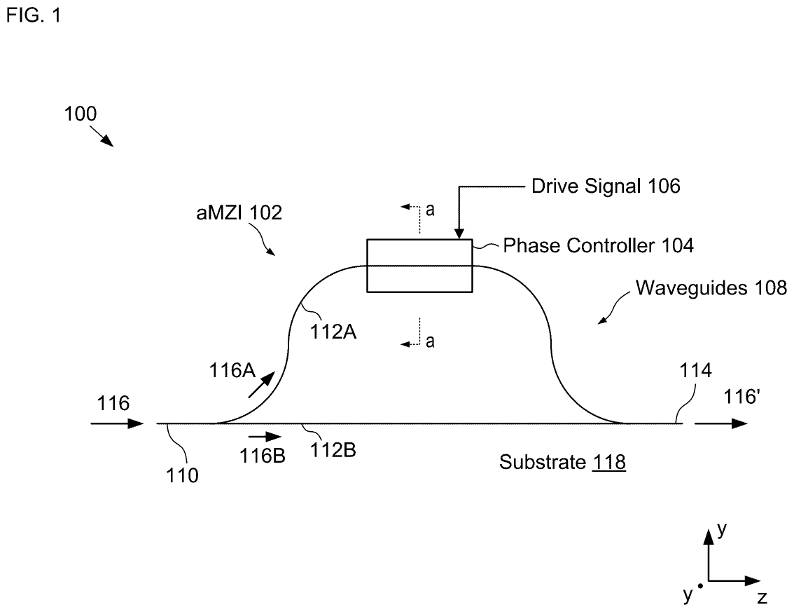

FIG. 1 depicts a schematic drawing of a top view of a PLC-based variable optical attenuator (VOA) comprising a stress-optic (SO) phase controller in accordance with the present disclosure. PLC 100 includes asymmetric Mach-Zehnder interferometer (aMZI) 102 and phase controller 104, which are arranged to define a variable optical attenuator (VOA) in which the intensity of a light signal is controlled via drive signal 106, which is applied to phase controller 104.

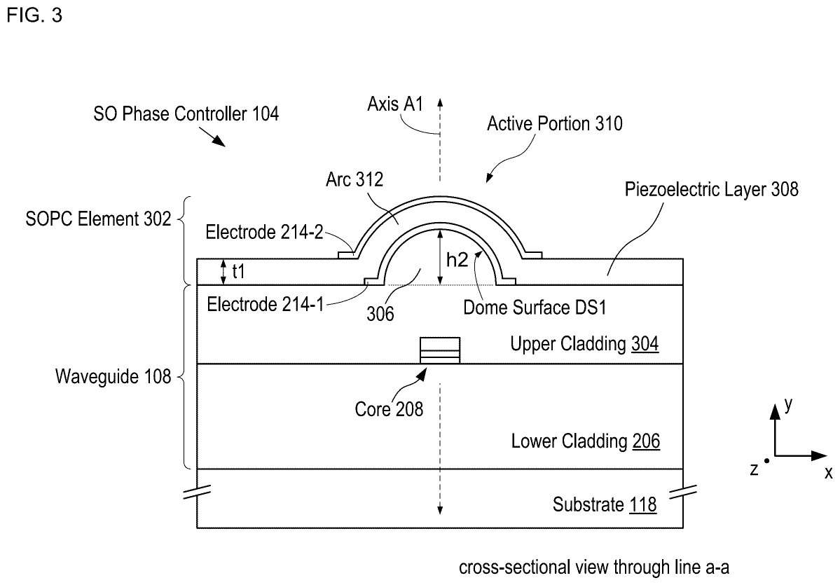

aMZI 102 is a network of waveguides 108 disposed on substrate 118, where the waveguides are arranged to define input port 110, arms 112A and 112B, and output port 114. Each of waveguides 108 is an integrated-optics waveguide having a multi-layer core disposed between a lower cladding and a domed upper cladding, as described in detail below and with respect to FIG. 3.

As will be apparent to one skilled in the art, substrate 118 can be any suitable substrate, such as a silicon wafer, compound semiconductor wafer, glass substrate, or myriad alternative substrates suitable for use in planar-processing fabrication.

In operation, aMZI 102 receives light signal 116 at input port 110 and splits its optical energy equally into light signals 116A and 116B on arms 112A and 112B, respectively. After light signal 116A has passed through phase controller 104, light signals 116A and 116B are recombined to define output signal 116′ at output port 114. As will be apparent to one skilled in the art, the optical power of recombined optical signal 116′ is based on the phase difference between light portions 116A and 116B when they recombine.

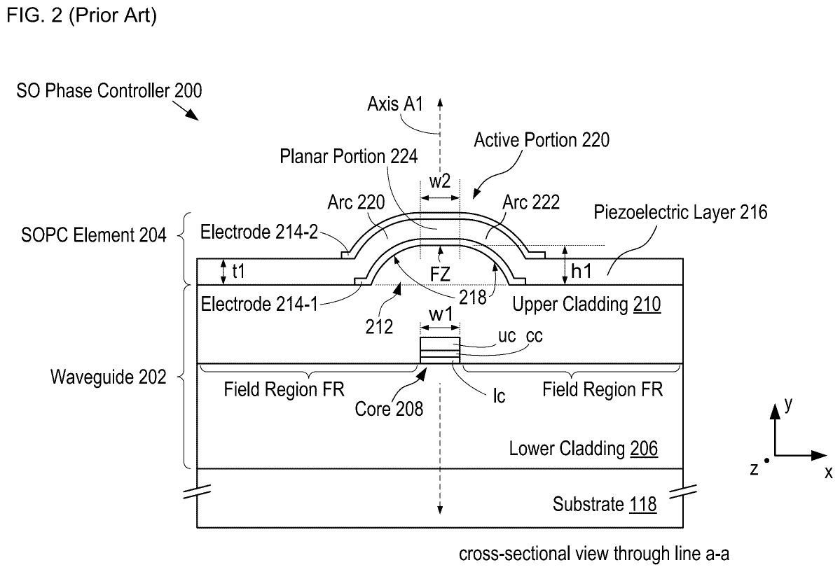

FIG. 2 depicts a schematic drawing of a cross-sectional view of an SO phase controller in accordance with the prior art. SO phase controller 200 comprises waveguide 202 and stress-optic phase-control (SOPC) element 204, which is disposed on the top surface of waveguide 202. The cross-sectional view shown in FIG. 2 is analogous to a view of SO phase controller 104 taken through line a-a of FIG. 1.

Waveguide 202 is an asymmetric double-stripe (ADS) TriPlex™ waveguide comprising lower cladding 206, core 208, and upper cladding 208. Waveguide 202 is analogous to waveguides described in, for example, PCT Pat. Pub. No. WO2019142151 and U.S. Pat. Pub. No. 2023/0152608, each of which is fully incorporated herein by reference.

Lower cladding layer 206 is a layer of silicon dioxide disposed on substrate 118. Lower cladding layer 206 is configured such that it has a thickness sufficient to mitigate optical coupling of optical energy from light signal 116 into the substrate.

Core 208 has width, w1, and comprises comprising lower core lc, central core cc, and upper core uc. In the depicted example, w1 is approximately 1 micron, and lower core lc, central core cc, and upper core uc have thicknesses of 75 nm, 100 nm, and 175 nm, respectively. However, a wide range of widths and thicknesses can be used for any of lower core lc, central core cc, and upper core uc.

Upper cladding 210 is a layer of silicon dioxide that is formed over core 208 such that the layer is conformal with the surface upon which it is formed. This surface includes field region FR (i.e., the surface of lower cladding 206 not covered by core 208) and the sidewalls and top of core 208. Because upper cladding 210 is a conformal coating, the projection of core 208 above field region FR gives rise to dome 212 having height, h1, which is disposed directly above core 208 such that the dome and core are centered on axis A1. In the depicted example, h1 is equal to 820 nm.

It should be noted that the conformal nature of the deposition of upper cladding 210 results in the top surface of dome 212 having a flat zone FZ and arcs 218 on either side of the flat zone. Flat zone FZ forms due to deposition of upper-cladding material on the planar top surface of core 208, while arcs 218 form due to the simultaneous deposition of material on the sidewalls of the dome and field region FR. It should be noted that, in the prior art, flat zone FZ forms such that it has width, w2, which is equal to or greater than width w1 of core 208.

SOPC element 204 is a stress-optic phase-control element comprising bottom electrode 214-1, piezoelectric layer 216, and top electrode 214-2, where the bottom electrode is in physical and electrical contact with the bottom surface of piezoelectric layer 216 and the top electrode is in physical and electrical contact with top surface of the piezoelectric layer. In the depicted example, electrodes 214-1 and 214-2 comprise platinum and have thicknesses of 200 nm and 300 nm, respectively, while piezoelectric layer 216 comprises lead zirconate titanate (PZT) and has a thickness, t1, of 1.5 microns.

SOPC element 204 is disposed on top cladding 210 such that the SOPC element is operatively coupled with waveguide 202. Typically, bottom electrode 214-1 is in direct physical contact with the top surface of dome 212. Due to the shape of dome 212 and the configuration of electrodes 214-1 and 214-2, piezoelectric layer 216 includes active portion 220, which is that portion of the layer disposed on dome 212. Active portion 220 includes two curved portions (i.e., arcs 222), disposed on the rounded sidewalls of the dome (i.e. arcs 218), and planar portion 224, which is disposed on flat zone FZ. Planar portion 224 forms such that it has substantially the same width (i.e., w2) as that of flat zone FZ.

Unfortunately, the presence of a significant planar portion 224 in SOPC element 204 reduces the effectiveness with which stress is induced in the materials of waveguide 202. Specifically, a planar portion having a width equal to or greater than the width of the core of its underlying waveguide has been found to have limited performance, which gives rise to a need for very long interaction lengths and/or very high drive voltages to achieve even a 2π phase change in a light signal propagating through its waveguide.

It is an aspect of the present disclosure that dome 212 can be configured such that its shape enhances the inducement of stress in the waveguide materials below it without also causing significant excess optical loss in light signal 116B as it propagates through phase controller 104.

Specifically, an SO phase controller in accordance with the present disclosure has significantly improved performance that is enabled by reducing the width of the planar portion of its SOPC element to be less than that of its underlying waveguide core or, preferably, eliminating it altogether. As discussed below, an SO phase controller in accordance with the teachings of the present disclosure includes a dome portion that has a flat zone whose width is narrower than the width of the core of its underlying waveguide or, preferably, a dome whose top surface includes no flat zone at all, thereby enabling one or more of larger phases changes, shorter interaction lengths, and lower drive voltages, among other advantages.

For the purposes of this Specification, including the appended claims, a “narrow flat zone” is defined as a substantially planar region of the top surface of an upper-cladding dome of an integrated-optics waveguide, where the narrow flat zone has a width that is less than the width of the underlying core of the waveguide.

FIG. 3 depicts a schematic drawing of a cross-sectional view of an SO phase controller in accordance with the present disclosure. SO phase controller 104 is analogous to SO phase controller 200; however, SO phase controller 104 includes a piezoelectric layer having an active portion that is completely nonlinear (i.e., it has no flat zone) along the direction orthogonal to the longitudinal direction of its waveguide because it is disposed on a dome structure that does not include a flat zone. SO phase controller 104 comprises waveguide 108 and SOPC element 302. The cross-sectional view shown in FIG. 3 is taken through line a-a of FIG. 1. In some embodiments, the active portion of the piezoelectric layer of an SOPC element does include a flat zone; however, in accordance with the present disclosure, such a flat zone is a narrow flat zone, as defined above.

In similar fashion to waveguide 202 described above, waveguide 108 is an asymmetric double-stripe (ADS) TriPlex™ waveguide comprising lower cladding 206, core 208, and upper cladding 304. Waveguide 108 is analogous to waveguides described in, for example, PCT Pat. Pub. No. WO2019142151 and U.S. Pat. Pub. No. 2023/0152608, each of which is fully incorporated herein by reference. It should be noted, however, that although the depicted example includes a multi-core ADS waveguide, the teachings of the present disclosure are applicable to virtually any waveguide structure, such as single-core waveguides comprising any suitable core material (e.g., silicon, doped silicon oxide, silicon oxynitride, silicon-nitride, compound semiconductor, etc.), multi-core symmetric waveguides comprising any combination of suitable core materials (e.g., silicon, doped silicon oxide, silicon oxynitride, silicon-nitride, compound semiconductor, etc.), and the like. Some non-limiting examples of waveguide structures particularly suitable for use in embodiments in accordance with the present disclosure are described in more detail in U.S. Pat. Nos. 7,146,087, 7,142,759, 9,221,074 and 9,764,352, each of which is incorporated herein by reference.

Methods suitable for forming an SO phase shifter in accordance with the present disclosure are analogous to exemplary fabrication methods described in detail in PCT Pat. Pub. No. WO2019/142151.

Upper cladding 304 is formed over patterned core 208 via conformal deposition of the top-cladding material such that the upper cladding includes dome 306. In some embodiments, additional processing steps are employed to refine the shape of dome 306, normally to remove or reduce a flat zone of the dome. In some embodiments, dome 306 is reshaped by creating a singular point, or a feature as close to a singular point as possible, rather than a flat zone above core 208 before the deposition of the top-cladding material 304. The singular point can be generated in multiple ways, such as lateral etching of the material. In some embodiments, additional masking and etch patterning is used.

Dome 306 is configured such that its top surface (i.e., dome surface DS1) steadily curves along the x-direction (as shown). In the depicted example, dome surface DS1 has a constant radius of curvature along the x-direction, thereby forming a substantially circular shape along this dimension. In some embodiments, the top surface of an upper-cladding dome has a different nonlinear shape along the x-direction, such as parabolic, sinusoidal, irregular, and the like. It should be noted that, in sharp contrast to the top surface of dome 212, dome surface DS1 does not include a flat zone above core 208.

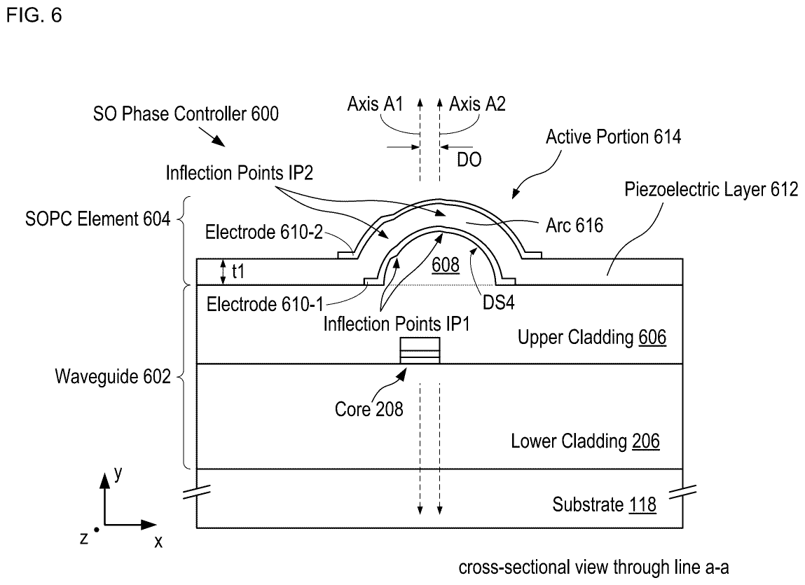

In some embodiments, an SO phase controller includes a slight lateral offset (along the x-direction, as indicated in FIG. 3) between core 208 and dome 306. In such embodiments, dome 306 develops relatively sharp features in its top surface as it forms above the core, as discussed in more detail below and with respect to FIG. 6. These sharp features can advantageously improve the efficiency with which stress is induced in the materials of an underlying waveguide in some cases.

SOPC element 302 is analogous to SOPC element 204 described above. As in SOPC element 204, electrodes 214-1 and 214-2 comprise platinum and have thicknesses of 200 nm and 300 nm, respectively, while piezoelectric layer 308 comprises lead zirconate titanate (PZT) and has a thickness, t1, of 1.5 microns. It should be noted, however, that the materials and dimensions provided here are merely exemplary and that any suitable materials and thicknesses can be used for any of bottom electrode 214-1, piezoelectric layer 216, and top electrode 214-2 without departing from the scope of the present disclosure. Furthermore, many alternative materials are suitable for use in piezoelectric layer 308 such as, without limitation, barium titanate, lead titanate, lithium niobate, bismuth ferrite, sodium niobate, and the like.

In the depicted example, lower electrode 214-1 is formed such that it is in direct physical contact with dome surface DS1. In some embodiments, however, at least one intervening layer of material is present between lower electrode 214-1 and dome surface DS1.

It is an aspect of the present disclosure that SOPC element 302 is configured such that its shape increases the effectiveness with which it creates stress in the waveguide layers of the waveguide on which it is disposed. Specifically, active portion 310 (i.e., the portion of SOPC element 302 disposed on dome surface DS1) has a shape that is completely nonlinear along the direction orthogonal (depicted as the x-direction in FIGS. 1 and 3) to the direction of propagation of light signal 116B through SO phase controller 104 (depicted as the z-direction in FIGS. 1 and 3). In other words, along the x-direction, active portion 310 includes only a single, continuous arc 312 that does not include a planar portion.

The shape of SOPC element 302 arises from its conformal deposition on dome 306. As a result, the constant radius of curvature of dome 306 along the x-direction gives rise to a substantially circular shape for arc 312 along this dimension.

As noted above, although dome 306 has a top surface that is substantially circularly shaped along the x-direction, other shapes for the surface of an upper-cladding dome (e.g., parabolic, sinusoidal, irregular, etc.) can be used without departing from the scope of the present disclosure.

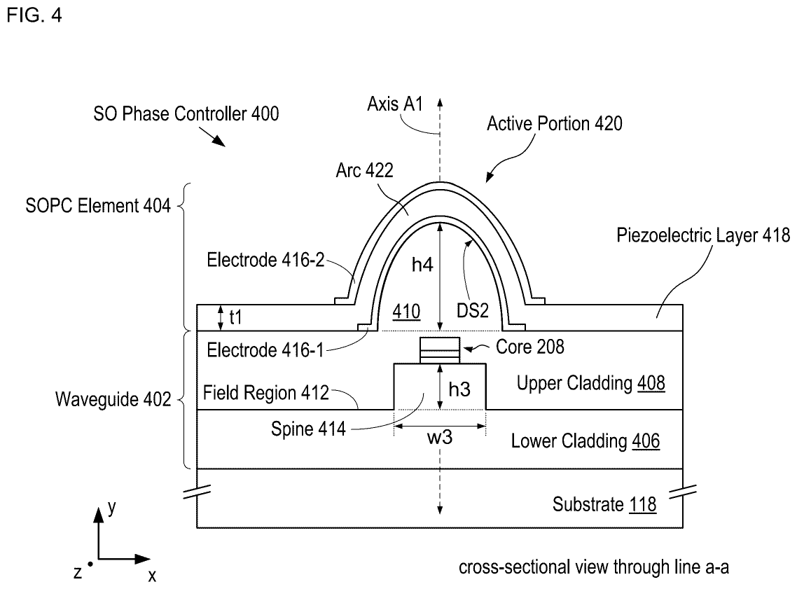

FIG. 4 depicts a schematic drawing of a cross-sectional view of another SO phase controller in accordance with the present disclosure. SO phase controller 400 includes waveguide 402 and SOPC element 404. SO phase controller 400 is analogous to SO phase controller 104; however, the dome structure in the upper cladding of waveguide 402 has a top surface that is substantially parabolic along the x-direction. The cross-sectional view shown in FIG. 4 is analogous to that taken through line a-a of FIG. 1.

Waveguide 402 is analogous to waveguide 108. In the depicted example, it is an asymmetric double-stripe (ADS) TriPlex™ waveguide comprising lower cladding 406, core 208, and upper cladding 408, which includes parabolic-shaped dome surface DS2.

Lower cladding 406 is analogous to lower cladding 202; however, a portion of lower cladding 406 is etched back to define field region 412 and spine 414. Spine 414 has width w3 and projects above field region 412 by height h3.

Upper cladding 408 is formed via conformal deposition of the top-cladding material onto field region 412, spine 414, and core 208.

Upper cladding includes dome 410. In some cases, additional processing steps are employed to refine the shape of dome surface DS2, normally to remove or reduce a flat zone present in the surface. In some embodiments, this is done by the use of lateral etching to create sharp features, sharp features etched vertically, or a combination thereof. In some embodiments, other known methods are used to create a sharp feature. In some embodiments, additional masking and etch patterning is used.

The shape of dome 410, as well as its height, h4, are based on the shape of spine 414, such as its width, w3, and height, h3. In the depicted example, the values of w3 and h3 give rise to a dome that has a substantially top parabolic surface that does not include a flat zone in the region above core 208.

SOPC element 404 is analogous to SOPC element 302 described above and includes lower electrode 416-1, piezoelectric layer 418, and upper electrode 416-2. Piezoelectric layer 418 includes active portion 420, which is defined by arc 422. Arc 422 has a substantially parabolic shape, which arises from its conformal deposition on dome surface DS2. Like dome surface DS2, therefore, arc 422 lacks a linear portion.

The lack of a linear portion in SOPC element 404 enables stress to be imparted into the waveguide materials of waveguide 402 more efficiently than can be achieved in prior-art SO phase controllers.

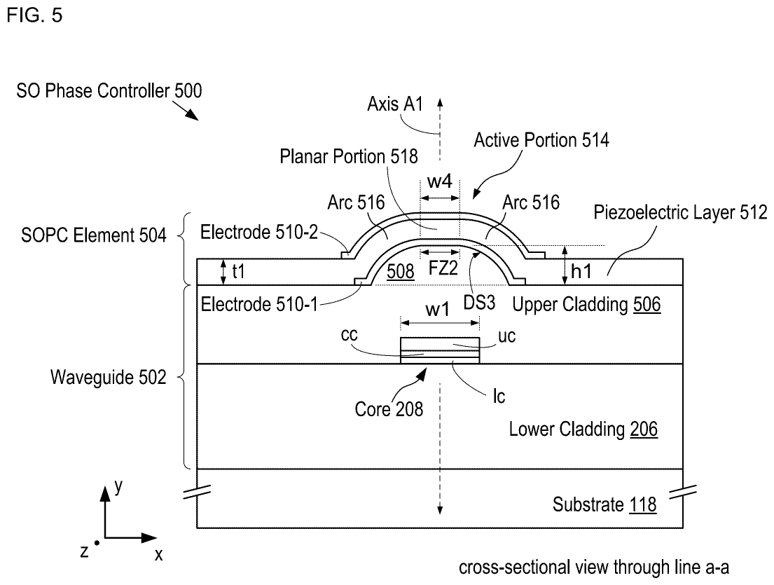

FIG. 5 depicts a schematic drawing of a cross-sectional view of yet another SO phase controller in accordance with the present disclosure. SO phase controller 500 includes waveguide 502 and SOPC element 504. SO phase controller 500 is analogous to SO phase controller 104. The cross-sectional view shown in FIG. 5 is analogous to that taken through line a-a of FIG. 1.

Waveguide 502 is analogous to waveguide 108. In the depicted example, it is an asymmetric double-stripe (ADS) TriPlex™ waveguide comprising lower cladding 206, core 208, and upper cladding 506, which includes dome 508 whose top surface (i.e., dome surface DS3) is quasi-circular-shaped along the x-direction and exhibits narrow flat zone FZ2.

Upper cladding 506 is formed via conformal deposition of the top-cladding material over core 208.

Upper cladding includes dome 508. In some cases, additional processing steps are employed to refine the shape of dome 508 to reduce the width of flat zone FZ2, which forms above core 208 during deposition. In some embodiments, lateral etching is used to create sharp features, sharp features etched vertically, or a combination thereof to create such a sharp feature. In some embodiments, additional masking and etch patterning is used.

The shape of dome surface DS3 is substantially circular along the x-direction; however, its top surface includes a “narrow flat zone” over the region of core 208, where the width w4 of flat zone FZ2 is less than the width, w1, of core 208.

SOPC element 504 is analogous to SOPC element 302 described above and includes lower electrode 510-1, piezoelectric layer 512, and upper electrode 510-2. Piezoelectric layer 512 includes active portion 514, which includes arcs 516 and planar portion 518, where the width of planar portion 518 is also less than the width, w1, of core 208.

The width of planar portion 518 is determined by the width, w4, of flat zone FZ2. Typically, planar portion 518 and flat zone FZ2 have the same width. Because planar portion 518 has a smaller width than the width of core 208 below it (i.e, w4<w1), SOPC element 504 can induce stress in the waveguide materials of waveguide 502 more efficiently than the SOPC elements of prior-art SO phase controllers.

FIG. 6 depicts a schematic drawing of a cross-sectional view of another SO phase controller in accordance with the present disclosure. SO phase controller 600 includes waveguide 602 and SOPC element 604. SO phase controller 600 is analogous to SO phase controller 104; however, in SO phase controller 600, there is a lateral offset between the dome formed in upper cladding of waveguide 602 and its core. The cross-sectional view shown in FIG. 6 is analogous to that taken through line a-a of FIG. 1.

Waveguide 602 is analogous to waveguide 108. In the depicted example, it is an asymmetric double-stripe (ADS) TriPlex™ waveguide comprising lower cladding 206, core 208, and upper cladding 606, which includes dome 608.

Upper cladding 606 is formed via conformal deposition of the top-cladding material over core 208 such that the upper cladding includes dome 608. It should be noted, however, that core 208 is centered on axis A1 while dome 608 is centered on central axis A2, where axes A1 and A2 are separated by a dome offset, DO, along the x-direction.

By virtue of dome offset DO, when dome 608 is formed via conformal deposition, at least one inflection point IP1 arises in dome surface DS4.

SOPC element 604 is analogous to SOPC element 302 described above and includes lower electrode 610-1, piezoelectric layer 612, and upper electrode 610-2. Piezoelectric layer 612 includes active portion 614, which includes arc 616 disposed on dome 608.

Due to the presence of inflection points IP1 in dome surface DS4, commensurate inflection points IP2 are formed in arc 616 of piezoelectric layer 610 during its conformal deposition on dome 608.

It is an aspect of the present disclosure that inflection points IP2 can be exploited as stress concentration points at which the magnitude of stress induced is magnified, thereby improving the efficiency with which stress can be induced in the materials of waveguide 602.

Each of the embodiments described above includes only SOPC elements having a piezoelectric layer disposed between lower and upper electrodes, referred to herein as a “top-bottom electrode configuration.” However, SOPC elements in accordance with the present disclosure are not limited to top-bottom electrode configurations. In some embodiments, for example, an SOPC element includes a pair of electrodes that reside on the top surface of its piezoelectric layer-referred to herein as a “top-top electrode configuration.”

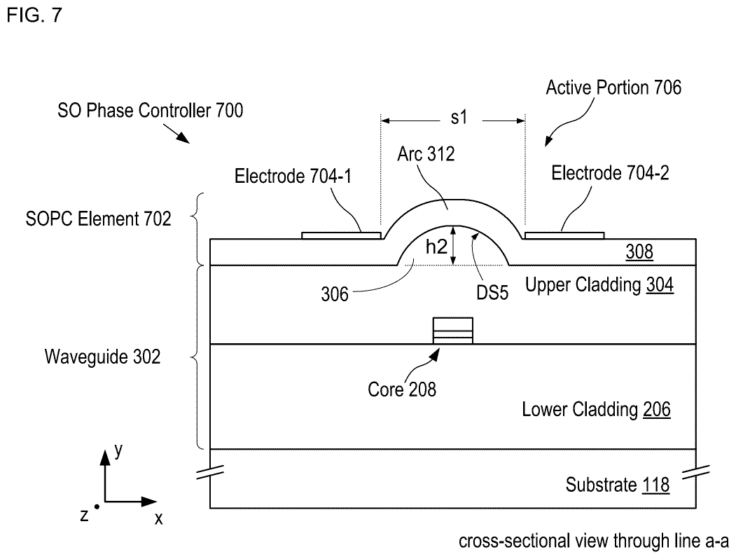

FIG. 7 depicts a schematic drawing of a cross-sectional view of yet another SO phase controller in accordance with the present disclosure. SO phase controller 700 includes waveguide 108 and SOPC element 702. SO phase controller 700 is analogous to SO phase controller 104; however, in SO phase controller 700, SOPC element 702 includes electrodes that are disposed on the same surface of piezoelectric layer 308 and located on either side of core 208. The cross-sectional view shown in FIG. 7 is analogous to that taken through line a-a of FIG. 1.

SOPC element 702 is analogous to SOPC element 302 described above; however, in SOPC element 702, electrodes 704-1 and 704-2 are disposed on the top surface of piezoelectric layer 308 such that they are located on opposite sides of core 208 and dome 306. For the purposes of this Specification, including the appended claims, an SOPC element whose electrodes are both disposed on the top surface of its piezoelectric layer is referred to as a top-top electrode configuration SO phase controller. Examples of phase-controller electrode configurations suitable for use in accordance with the present disclosure are described in detail in U.S. patent application Ser. No. 17/988,653, filed Nov. 16, 2022 (Attorney Docket: 142-043US1), the entirety of which is incorporated herein by reference.

Like SOPC element 302, SOPC element 702 is configured such that its shape increases the effectiveness with which it creates stress in the waveguide layers of the waveguide on which it is disposed. Specifically, active portion 706 (i.e., the portion of SOPC element 702 disposed on dome surface DS5 of dome 306) has a shape that is completely nonlinear along the direction orthogonal (depicted as the x-direction in FIGS. 1 and 3) to the direction of propagation of light signal 116B through SO phase controller 104 (depicted as the z-direction in FIGS. 1 and 3). In other words, along the x-direction, active portion 706 includes only a single, continuous arc 312 that does not include a planar portion.

As discussed above, in some embodiments, an SOPC element having a top-top electrode configuration includes an upper-cladding dome and an active portion that do include a “narrow flat zone,” which is characterized by a width that is less than the width of core 208.

In some embodiments, a PLC includes a mixture of SOPC elements having top-top and top-bottom electrode configurations.

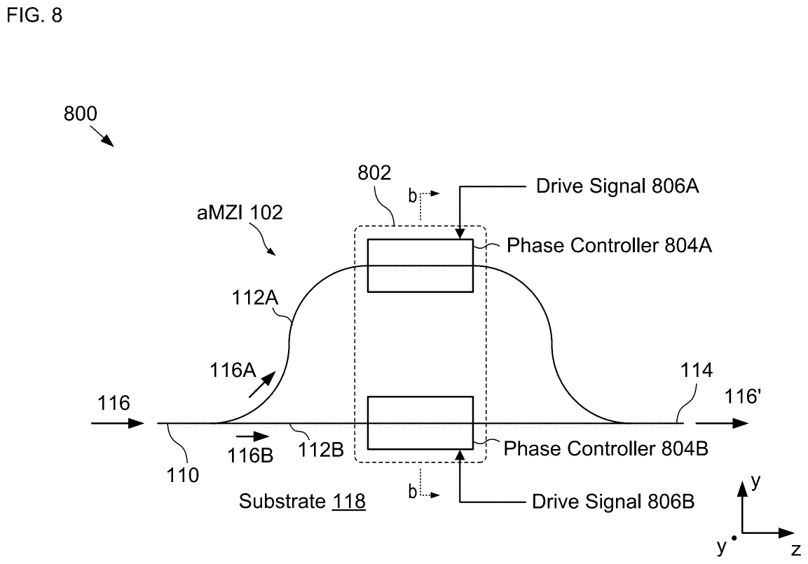

FIG. 8 depicts a schematic drawing of a top view of an alternative embodiment of a PLC-based VOA comprising SO phase controllers on each arm of an aMZI in accordance with the present disclosure. PLC 800 is analogous to PLC 100 described above, with the addition of phase-control module 802, which is operatively coupled with aMZI 102.

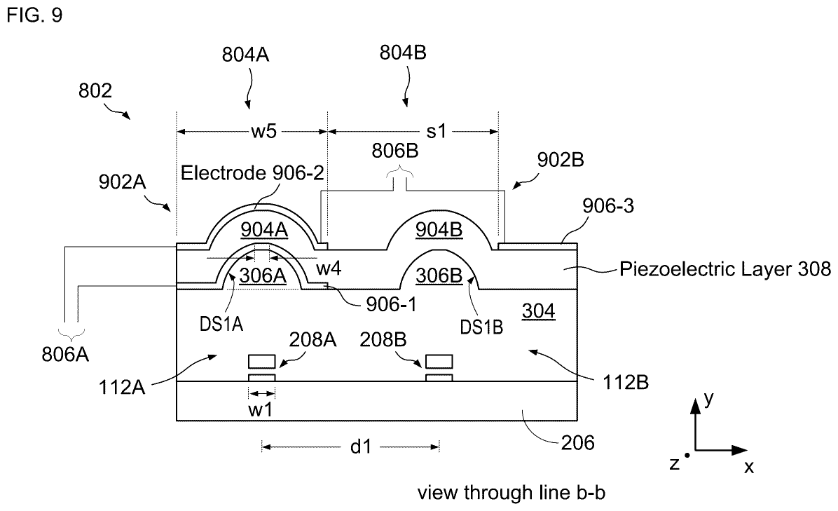

FIG. 9 depicts a schematic drawing of a cross-sectional view of phase-control module 802 taken through line b-b as shown in FIG. 8.

Phase-control module 802 includes SO phase controller 804A and SO phase controller 804B, which are operatively couple with arms 112A and 112B, respectively.

SO phase controller 804A is a top-bottom electrode-configuration SO phase controller that is analogous to SO phase controller 500, described above. SO phase controller 804A includes SOPC element 902A, which is disposed on dome surface DS1A of dome 306A. SOPC element 902A includes a first portion 904A of piezoelectric layer 308, which is located between lower electrode 906-1 and upper electrode 906-2. Electrodes 906-1 and 906-2 have width w5, which, in the depicted example, is approximately 10 microns.

SO phase controller 804B is a top-top electrode-configuration SO phase controller that is analogous to SO phase controller 700, described above. SO phase controller 804B includes SOPC element 902B, which is disposed on dome surface DS1B of dome 306B. SOPC element 806B includes electrodes 906-2 and 906-3, which are located on the top surface of second portion 904B of piezoelectric layer 308. In the depicted example, the separation, s1, between electrodes 906-2 and 906-3 is 10 microns.

The different electrode configurations of SO phase controllers 804A and 804B enable their use in concert to generate complicated and, in some embodiments, complimentary stress/strain fields in arms 112A and 112B in response to drive signals 806A and 806B, respectively.

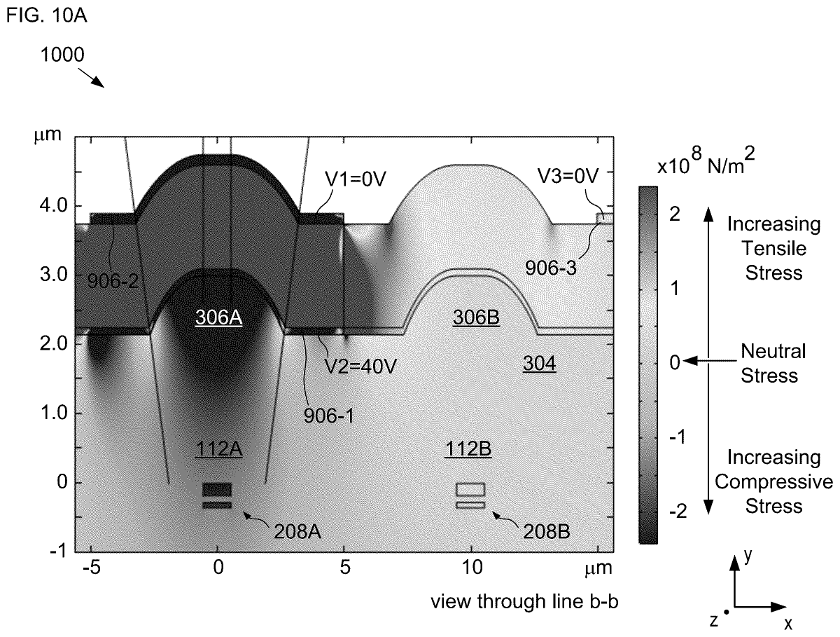

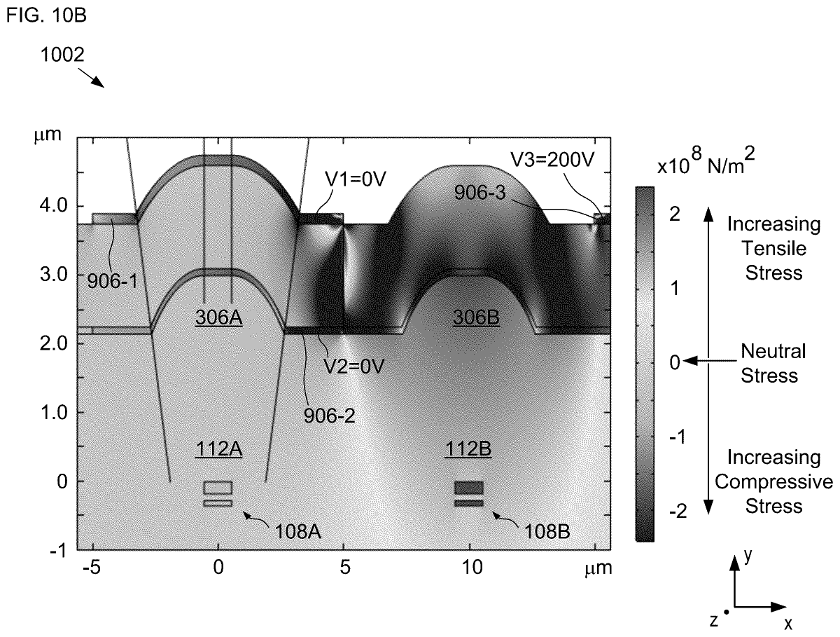

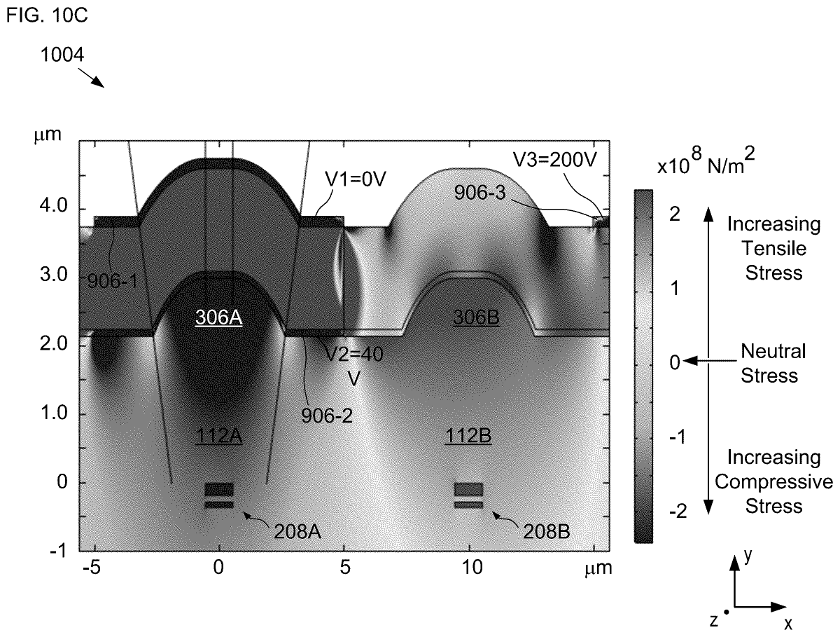

FIGS. 10A-C depict simulations showing the stress fields developed in arms 112A and 112B in response to different voltage configurations applied to electrodes 906-1 through 906-3.

Plot 1000 shows the composite stress fields (combined x-, y-, and z-components) when voltages of 0, 40, and 0 volts are applied to electrodes 906-1, 906-2, and 906-3, respectively.

Plot 1002 shows the composite stress fields when voltages of 0, 0, and 200 volts are applied to electrodes 906-1, 906-2, and 906-3, respectively.

Plot 1004 shows the composite stress fields when voltages of 0, 40, and 200 volts are applied to electrodes 906-1, 906-2, and 906-3, respectively.

As is clear from plot 1004, large-magnitude stresses having opposite sign can be induced in arms 112A and 112B.

It is to be understood that the disclosure teaches just one example of the illustrative embodiment and that many variations of embodiments in accordance with the present disclosure can easily be devised by those skilled in the art after reading this disclosure and that the scope of the present invention is to be determined by the following claims.

What is claimed is:

1. An integrated-optics-based photonics circuit comprising a first phase controller, wherein the first phase controller includes:
a first waveguide disposed on a substrate, the first waveguide including:
(i) a first lower cladding;
(ii) a first core disposed on the first lower cladding, wherein the first core has a first width; and
(iii) a first upper cladding disposed on the first core, wherein the first upper cladding includes a first dome having a first surface that includes a first flat zone having a second width that is less than the first width, wherein the first dome is at least partially disposed above the first core; and
a first stress-optic phase control (SOPC) element disposed on the first dome, wherein the first SOPC element includes:
(i) a first portion of a piezoelectric layer; and
(ii) first and second electrodes that are electrically connected with the piezoelectric layer;
wherein the first SOPC element is operative for inducing a first refractive-index change in the first waveguide by imparting a first stress in at least one of the first core and first upper cladding.

2. The photonics circuit of claim 1 wherein the second width is substantially zero.

3. The photonics circuit of claim 1 further comprising a plurality of waveguides that includes the first waveguide, wherein the plurality of waveguides is arranged to define a Mach-Zehnder Interferometer (MZI) having an input port, a first arm, a second arm, and an output port, wherein the first arm includes the first phase controller.

4. The photonics circuit of claim 3 wherein the MZI is an asymmetric MZI and the first arm and second arm have different lengths.

5. The photonics circuit of claim 1 wherein the first core is centered on a first axis and the first dome is substantially centered on the first axis.

6. The photonics circuit of claim 1 wherein the first core is centered on a first axis and the first dome is centered on a second axis, and wherein the first and second axes are separated along a first dimension by a dome offset that is nonzero.

7. The photonics circuit of claim 1 further comprising a phase-control module that includes the first SO phase controller and a second SO phase controller, wherein the second SO phase controller comprises:
a second waveguide disposed on the substrate, the second waveguide including:
(i) the first lower cladding;
(ii) a second core disposed on the second lower cladding; and
(iii) the first upper cladding disposed on the second core, wherein the first upper cladding includes a second dome that is substantially aligned with the second core; and
a second SOPC element disposed on the second dome, wherein the SOPC element includes:
(i) a second portion of the piezoelectric layer; and
(ii) a third electrode and a fourth electrode that are electrically connected with the second portion of the piezoelectric layer;
wherein the second SOPC element is operative for inducing a second refractive-index change in the second waveguide by imparting a second stress in at least one of the second core and first upper cladding.

8. The photonics circuit of claim 7 wherein the first electrode is disposed on the first surface (DS1A), the piezoelectric layer is disposed on the first electrode, and the second electrode is disposed on the first portion of the piezoelectric layer, and wherein the second portion of the piezoelectric layer includes an active region disposed on the second dome and the third and fourth electrodes are disposed on the piezoelectric layer on opposite sides of the active region.

9. The photonics circuit of claim 7 further comprising a plurality of waveguides that includes the first and second waveguides, wherein the plurality of waveguides is arranged to define a Mach-Zehnder Interferometer (MZI) having an input port, a first arm, a second arm, and an output port, and wherein the first arm includes the first waveguide and the second arm includes the second waveguide.

10. A method for forming a planar-lightwave circuit (PLC) on a substrate, the method comprising:
forming a first waveguide on the substrate such that the first waveguide includes a first lower cladding, a first core having a first width, and a first upper cladding having a first dome having a first flat zone having a second width that is less that the first width; and
forming a first stress-optic phase control (SOPC) element disposed on the first dome, wherein the SOPC element includes a first piezoelectric layer, a first electrode and a second electrode that are electrically connected with the first piezoelectric layer;
wherein the first SOPC element is formed such that it is operative for inducing a first refractive-index change in the first waveguide by imparting a first stress in at least one of the first core and the first upper cladding.

11. The method of claim 10 wherein the first waveguide is formed such that the second width is zero.

12. The method of claim 10 wherein the first waveguide is formed such that the first dome has a first surface that has a shape along a first direction, the shape being selected from the group consisting of circular, parabolic, and quasi-circular, and irregular.

13. The method of claim 10 further comprising forming a second phase controller, wherein the second phase controller is formed by operations that include:
forming a second waveguide of the PLC, wherein the second waveguide includes the first lower cladding, a second core, and the first upper cladding disposed on the second core, wherein the first upper cladding includes a second dome that is substantially aligned with the second core; and
forming a second SOPC element disposed on the second dome, wherein the second SOPC element includes a second portion of the piezoelectric layer, a third electrode and a fourth electrode that are electrically connected with the second portion of the piezoelectric layer;
wherein the second SOPC element is formed such that it is operative for inducing a second refractive-index change in the second waveguide by imparting a second stress in at least one of the second core and the first upper cladding.

14. The method of claim 13 wherein the first phase controller is formed such that the first electrode is disposed on the first dome, the first portion of the piezoelectric layer is disposed on the first electrode, and the second electrode is disposed on the first portion of the piezoelectric layer, and wherein the second phase controller is formed such that the second portion of the piezoelectric layer is disposed on the second dome and the third and fourth electrodes are disposed on the piezoelectric layer such that they are on either side of the second portion and the second dome.

15. The method of claim 14 further forming a plurality of waveguides that includes the first and second waveguides, the plurality of waveguides being arranged to define a Mach-Zehnder Interferometer (MZI) having an input port, first and second arms, and an output port, wherein the first arm includes the first waveguide and the first SOPC element, and wherein the second arm includes the second waveguide and the second SOPC element.

16. The method of claim 15 wherein the plurality of waveguides is formed such that the MZI is an asymmetric Mach-Zehnder Interferometer (aMZI) and the first and second arms are of unequal length.

17. The method of claim 10 wherein the first waveguide is formed such that the first core is centered on a first axis and the first dome is substantially centered on the first axis.

18. The photonics circuit of claim 10 wherein the first waveguide is formed such that the first core is centered on a first axis and the first dome is centered on a second axis, and wherein the first and second axes are separated along a first dimension by a dome offset that is nonzero.
